(19) United States
(12) Patent Application Publication
(10) Pub. No.: US 2008/0163045 A1
(43) Pub. Date: Jul. 3, 2008

(54) PROCESSES AND SYSTEMS FOR PROCESSING, DISPLAYING AND/OR OTHERWISE PRESENTING NON-PROGRAM DATA

(76) Inventor: David Christopher St. John-Larkin, Denver, CO (US)

Correspondence Address: EchoStar Technologies, L.L.C., c/o Dorsey & Whitney LLP, 370 Seventeenth St, Suite 4700, Denver, CO, 80202, US

(21) Appl. No.: 11/618,703

(22) Filed: Dec. 29, 2006

(51) Int. Cl. G06F 17/00

(52) U.S. Cl. 715/273

(57) ABSTRACT

A process of processing, displaying and/or otherwise presenting non-program data may include: receiving and processing, displaying and/or otherwise presenting program data at a client device; analyzing the program data processed, displayed and/or otherwise presented at the client device; and processing, displaying and/or otherwise presenting non-program data at the client device based on the analysis of the processed, displayed and/or otherwise presented program data. A system for processing, displaying and/or otherwise presenting non-program data may include: a receiver configured to receive a signal including program data; and a processor configured to analyze program data received by the receiver and to cause non-program data to be processed, displayed and/or otherwise presented based on the analysis of the processed, displayed and/or otherwise presented program data. Such exemplary process and system may provide post reception analysis of program data for management of non-program data, such as advertising.

### BACKGROUND

The inventive filed relates generally to displaying non-program data in association with program data that is transmitted from a source to a client device such as a television receiver. The inventive field also relates to analyzing program data that is displayed by the client device to trigger or otherwise control the processing, displaying or otherwise presenting of non-program data.

Signals carrying program data, i.e., feature content, are generally transmitted along with non-program data, content such as advertising, for display by one or more client devices. The signals may be transmitted via cables or wirelessly, for example, by satellite, as is well known in the art. The non-program data may be inserted into the signals by a provider of the content data or content provider, or by an uplink facility.

The non-program data, such as advertising, may be inserted at a point closer to client devices within a particular region, for example, by a local content provider. This allows different non-program data to be provided to different regions so that the non-program data provided is related to the particular region. In the case of advertising as the non-program data, such an approach allows a certain degree of targeted advertising, for example, by providing advertising for businesses that serve the particular region.

### SUMMARY

There is a need to provide more tailored non-program content to client devices so that users of the client devices are provided with non-program content that is relevant and/or of interest to them.

There is also a need to reduce reliance on content providers for information regarding the users of the client devices. It may be advantageous, for example, to allow content providers to manage only non-program content for a relatively large region, without requiring any specific knowledge of the users.

In view of such needs, exemplary embodiments of the invention relate to improving systems and processes for processing, displaying and/or otherwise presenting non-program data. In particular, exemplary embodiments allow for client-side management of non-program content as opposed to exclusively provider-side management.

Exemplary embodiments of the invention may provide post-reception analysis of program data, that is, analysis of program data that is processed, displayed and/or otherwise presented by a client device, so that non-program data may be processed, displayed and/or otherwise presented by the client device that is related to the processed, displayed and/or otherwise presented program data based on the analysis.

For example, embodiments of the invention may provide a process of processing, displaying and/or otherwise presenting non-program data including: receiving and processing, displaying and/or otherwise presenting program data at a client device; analyzing the program data processed, displayed or presented at the client device; and processing, displaying and/or otherwise presenting non-program data at the client device based on the analysis of the processed, displayed or presented program data.

In exemplary embodiments, the client device may include a storage device. In such embodiments, the process may further comprise storing the non-program data in the storage device for displaying based on the analysis.

In exemplary embodiments, analyzing the processed, displayed or presented program data may comprise analyzing content of the processed, displayed or presented program data. In such embodiments, analyzing the content of the processed, displayed or presented program data may comprise identifying at least one of a sound, a word, an image and an event in the processed, displayed or presented program data.

In exemplary embodiments, analyzing the processed, displayed or presented program data may additionally or alternatively comprise analyzing metadata of the processed, displayed or presented program data.

In exemplary embodiments, processing, displaying and/or otherwise presenting the non-program data may comprise displaying or otherwise presenting advertising related to the processed, displayed or presented program data. Additionally or alternatively, processing, displaying and/or otherwise presenting the non-program data may comprise displaying or otherwise presenting a user selectable link to data related to the processed, displayed or presented program data.

In exemplary embodiments, processing, displaying and/or otherwise presenting the non-program data may comprise inserting the non-program data into a signal carrying the program data. In such embodiments, inserting the non-program data into the signal may comprise overwriting preexisting non-program data in the signal. Additionally or alternatively, processing, displaying and/or otherwise presenting the non-program data may comprise adding the non-program data to the program data and simultaneously displaying or presenting the non-program data and a portion of the program data.

In exemplary embodiments, the process may further comprise generating a user profile based at least in part on the processed, displayed or presented program data. In such embodiments, analyzing the processed, displayed or presented program data may include analyzing the user profile. Further, generating the user profile may be based on at least one user preference.

Where appropriate or desired, analyzing the processed, displayed or presented program data may comprise a heuristic analysis.

Exemplary embodiments of the invention may provide a system for processing, displaying and/or otherwise presenting non-program data, comprising: a receiver configured to receive a signal including program data; and a processor configured to analyze program data received by the receiver and to cause non-program data to be processed, displayed or otherwise presented based on the analysis of the processed, displayed or presented program data. For example, the system may include a display configured to display program data received by the receiver; and the processor may be configured to analyze program data processed, displayed or presented by the display and to cause the display to display non-program data based on the analysis of the processed, displayed or presented program data.

In exemplary embodiments, the system may further comprise a storage device configured to store non-program data. In such embodiments, the processor may be configured to access the non-program data stored by the storage device and to provide selected non-program data based on the analysis of the processed, displayed or presented program data. Further, the storage device may comprise a client device.

In exemplary embodiments, the processor may be configured to analyze content of the processed, displayed or presented program data. In such embodiments, the processor may be configured to identify at least one of a sound, a word, an image and an event in the processed, displayed or presented program data.

In exemplary embodiments, the non-program data may comprise advertising. Additionally or alternatively, the non-program data may comprise a user selectable link to data.

In exemplary embodiments, the system may further comprise a user profile. In such embodiments, the processor may be configured to analyze the user profile and the processed, displayed or presented program data.

In exemplary embodiments, the processor may be configured to perform a heuristic analysis of the processed, displayed or presented program data.

Exemplary embodiments of the invention may provide a computer-readable storage medium including instructions for: receiving and processing, displaying and/or otherwise presenting program data at a client device; analyzing the program data processed, displayed or presented at the client device; and at least one of processing, displaying and presenting non-program data at the client device based on the analysis of the processed, displayed or presented program data.

By using various exemplary embodiments, non-program data that is tailored to a user of the client device may be processed, displayed or presented. The non-program data to be processed, displayed or presented may be selected based on content of the program data that is processed, displayed or presented at the client device. The non-program data to be processed, displayed or presented may also be selected based on a profile of the user. Such approaches may provide non-program content that is of particular interest to the user, and, for example, may provide targeted advertising that is effective because of such interest.

### BRIEF DESCRIPTION OF THE DRAWINGS

Various details of the present invention may will be better understood on reading the following detailed description of non-limiting embodiments, and on examining the accompanying drawings, in which:

FIG. 1 is a flowchart illustrating an exemplary process of displaying non-program data;

FIG. 2 is a flowchart illustrating another exemplary process of displaying non-program data;

FIG. 3 is a flowchart illustrating another exemplary process of displaying non-program data;

FIG. 4 is a flowchart illustrating another exemplary process of displaying non-program data;

FIG. 5 is a block diagram of an exemplary system for displaying non-program data; and

FIG. 6 is a block diagram of another exemplary system for displaying non-program data.

### DETAILED DESCRIPTION OF EMBODIMENTS

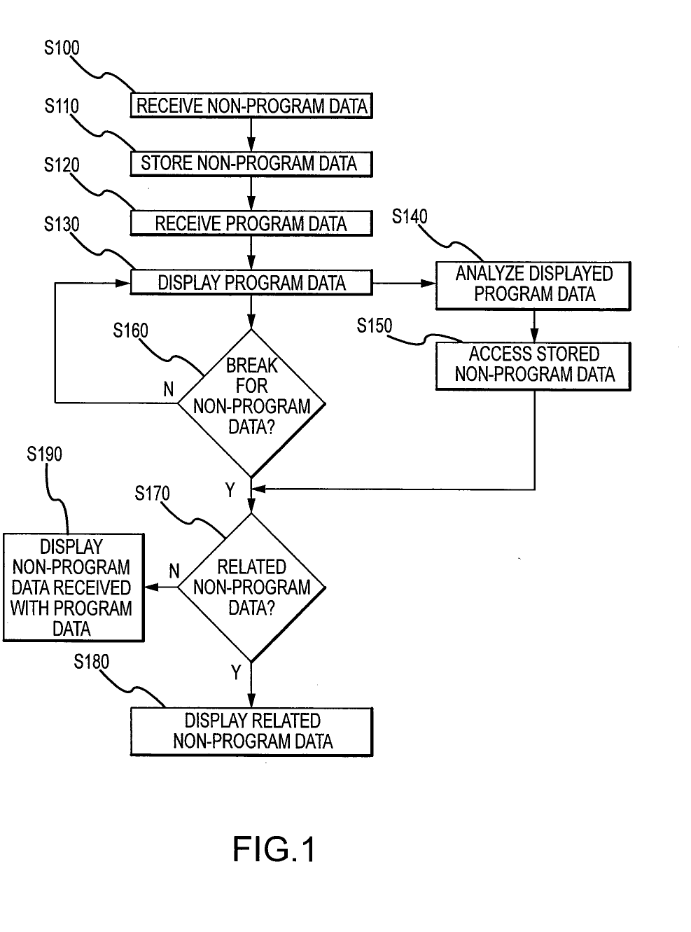

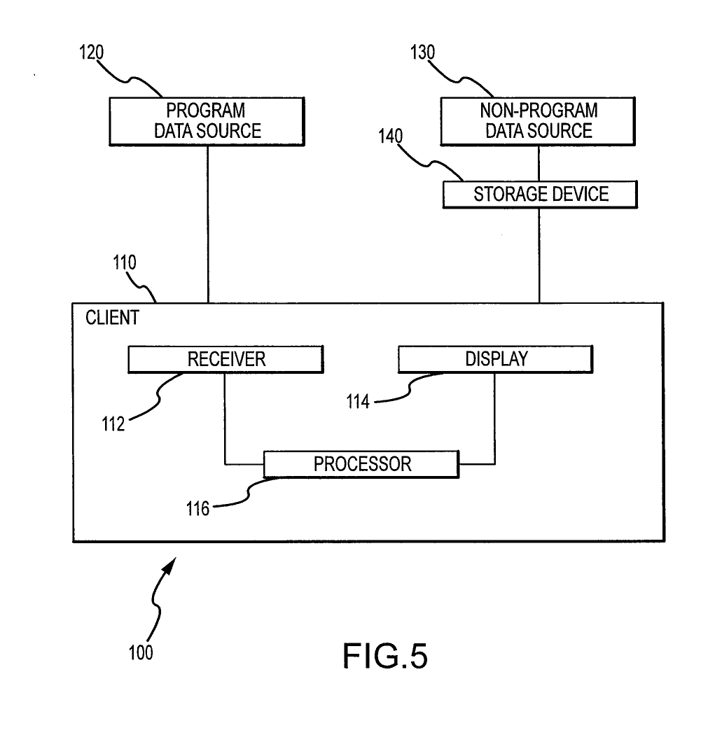

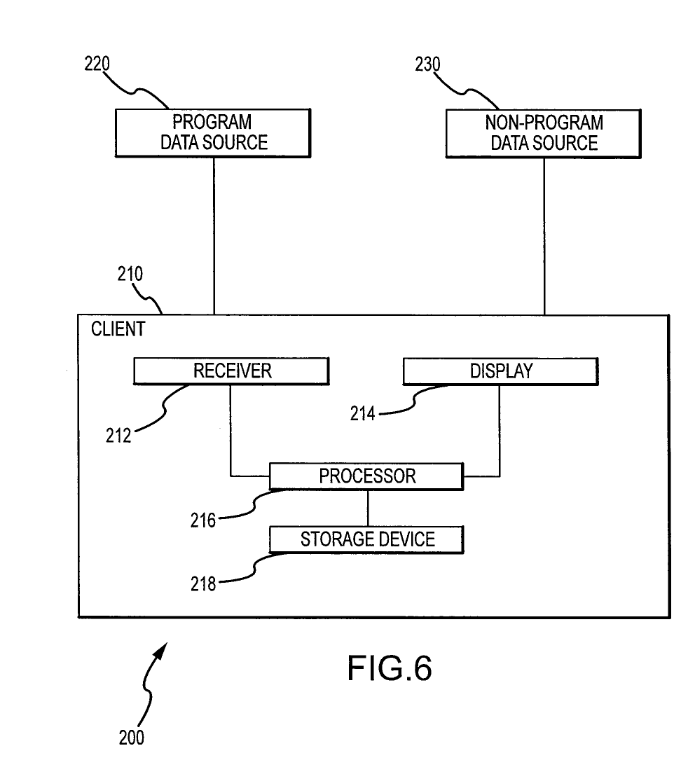

The exemplary flowcharts shown in FIGS. 1-4 and the exemplary block diagrams shown in FIGS. 5 and 6 are for illustration only and are not intended to represent the only possible process flows and system configurations. In particular, although only “displaying” is illustrated, it should be understood that processing, displaying and/or otherwise presenting data is encompassed by the description. Furthermore, process steps may be added, omitted and reordered as may be suitable to a particular application. Also, individual components may be added, omitted, replaced and interrelated as may be suitable to a particular application. All details appurtenant to implementing the exemplary processes and systems that are well understood in the art are omitted for simplicity and clarity.

The exemplary embodiments shown in the Figures illustrate processes and systems that may provide post reception analysis of program data for managing non-program data. Such analysis may allow client-side management of non-program data, which may reduce the need for content provider knowledge regarding users of client devices that receive program data therefrom. The analysis may allow the non-program data that is processed, displayed or otherwise presented at a particular client device to be related to the program data that is processed, displayed or otherwise presented at the particular client device. Thus, the non-program data processed, displayed or presented may be based on the program data that is processed, displayed or presented, which may provide more relevant and/or interesting non-program content for the user.

Throughout this disclosure, the term “program data” is meant to generally refer to programming, such as shows, movies, telecasts and the like, that is provided to a client device. On the other hand, the term “non-program data” is meant to refer to data, such as advertising, data links and other data, that may be associated with the transmission and display of program data based on a client side analysis of program data.

An exemplary process of displaying non-program data is illustrated by the flowchart shown in FIG. 1. The process may begin in step S100 in which non-program data is received. The non-program data may be received by a client device, such as a digital video recorder (DVR), or may be received by any other suitable storage device that is accessible to the client device, and then stored in step S110. For example, non-program data may be downloaded to a plurality of client devices or to a central storage device that is accessible to a plurality of client devices.

In step S120, program data may be received by a client device, such as a receiver or tuner. For example, a content provider may transmit program data to a plurality of client devices according to scheduled programming for a particular region. Based on a selection made by a user of an individual client device, program data selected from the received program data may be displayed in step S130, for example, on a television screen other display device.

In the exemplary embodiment shown, the program data displayed in step 130 is analyzed in step S140. Any suitable analysis of the displayed program data may be used that provides results that allow non-program data to be identified and/or selected as related to the displayed program data. For example, the analysis may be of the content of the displayed program data or of the metadata of the displayed program data. In particular, the displayed program data may be analyzed to identify a sound, a word, an image or an event in the displayed program data. Such analysis may be heuristic, as appropriate or desired. The analysis may be performed by a processor, for example, running software designed for the particular type of analysis desired.

Based on results of the analysis of the displayed program data in step S140, the stored non-program data may be accessed to identify and/or select non-program data that is related to the displayed program data. The identified/selected non-program data may then be provided to the display device for display in accordance with a determined or predetermined protocol.

For example, program data is typically transmitted with breaks for non-program data. The breaks are typically filled with non-program data by the source of the program data and transmitted with the program data or non-program data is added to fill the breaks by a local content provider prior to reception by client devices. Thus, as shown in the exemplary embodiment of FIG. 1, a determination of whether a break for non-program data exists in the program data being displayed is made in step S160.

If no break for non-program data is identified, then the process continues with displaying the program data in step S130. If a break for non-program data is identified, then a further determination is made in step S170 as to whether non-program data from the stored non-program data has been identified/selected as being related to the displayed program data.

If non-program data has been identified/selected as being related to the displayed program data, then that non-program data may be displayed during the break in the program data in step S180. For example, the identified/selected non-program data may be inserted into a time slot left open for such purpose or may replace or overwrite part of the non-program data received with the program data. However, if none of the stored non-program data has been identified/selected as being related to the displayed program data, then the process may continue to step S190 in which the non-program data received with the program data is displayed.

It should be understood that the flowchart of FIG. 1 does not illustrate loops of the process for the sake of simplicity and clarity. For example, the return to displaying program data after completion of the break for non-program data or after completion of the displaying of non-program data is omitted.

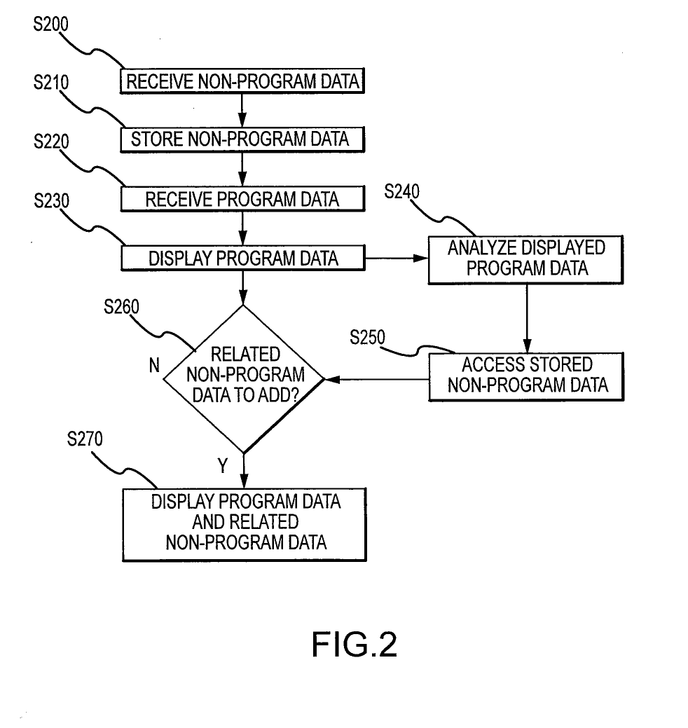

Another exemplary process of displaying non-program data is illustrated by the flowchart shown in FIG. 2. The process may be similar to that described with respect to FIG. 1, with like numbered steps corresponding. Thus, only differences between the flowcharts of FIGS. 1 and 2 will be described.

Whereas the flowchart of FIG. 1 illustrates a situation in which program data is transmitted with breaks for non-program data and non-program data that is identified/selected based on analysis of the displayed program data is inserted for display, the flowchart of FIG. 2 illustrates a situation in which non-program data that is identified/selected based on analysis of the displayed program data is added to the program data to be simultaneously displayed with part of the program data.

Thus, steps S200, S210, S220, S230, S240 and S250 in FIG. 2 may be described as above with respect to corresponding steps S100, S110, S120, S130, S140 and S150 in FIG. 1. However, in step S260, a determination as to whether non-program data from the stored non-program data has been identified/selected for addition to the program data as being related to the displayed program data.

If non-program data has been identified/selected for addition as being related to the displayed program data, then that non-program data may be added to the program data or otherwise displayed simultaneously with part of the program data in step S270. For example, the identified/selected non-program data may be an overlay or replacement of part of the program data that is displayed with a remaining part of the program data. In particular, the non-program data may comprise a user selectable link to data that is related to the displayed program data. For example, if the program data includes images, words or an event that is related to tourism in Hawaii, then a user selectable link to information regarding a Hawaii resort or a travel agency may be displayed as non-program data related to the displayed program data. If none of the stored non-program data is identified/selected as being related to the displayed program data, then the process may return to step S230 to display only the program data.

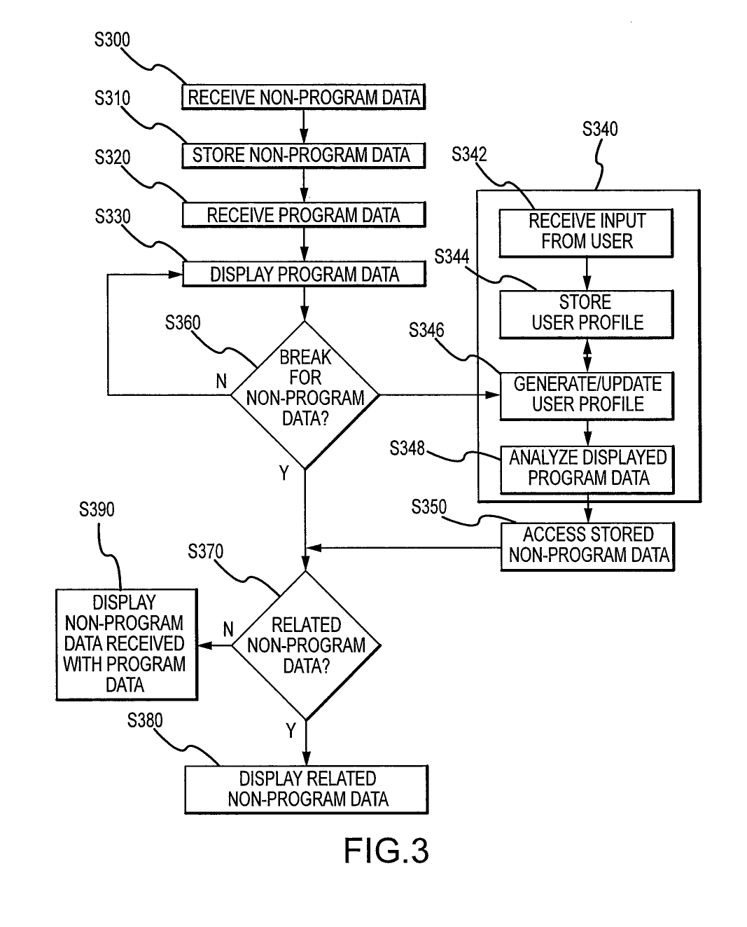

Another exemplary process of displaying non-program data is illustrated by the flowchart shown in FIG. 3. The process may be similar to that described with respect to FIG. 1, with like numbered steps corresponding. Thus, only differences between the flowcharts of FIGS. 1 and 3 will be described.

The flowchart of FIG. 3 differs from the flowchart of FIG. 1 only with respect to step S140 of FIG. 1. Thus, steps S300, S310, S320, S330, S350, S360, S370, S380 and S390 in FIG. 3 may be described as above with respect to corresponding steps S100, S110, S120, S130, S150, S160, S170, S180 and S190 in FIG. 1. However, in step S340, the analysis may be expanded to include a user profile feature.

As illustrated in FIG. 3, step S340 may include steps S342, S344, S346 and S348. In step S342, a user may input information regarding himself, such as his age, or his preferences, such as display options. The input information may be stored as part of a user profile in step S344. Although steps S342 and S344 are illustrated as part of step S340, it should be understood that steps S342 and S344 may occur at any time in the process. For example, a user may input preferences or other information specific to the user that may be stored prior to any program data is received.

In step S346, a user profile may be generated, or the user profile stored in step S344 may be updated, based on the displayed program data. For example, information regarding types, times, frequency, and the like, of program data displayed may be used to generate and/or update the user profile. Then, in step S348, not only may the displayed program data be analyzed, the user profile may also be analyzed. Similar as described above with respect to FIG. 1, based on results of the analysis of the displayed program data and/or the user profile, the stored non-program data may be accessed to identify and/or select non-program data that is related to the displayed program data. Thus, according to this exemplary process, a more tailored identification/selection of non-program data for display may be based on information in a user profile in addition to information in the displayed program data.

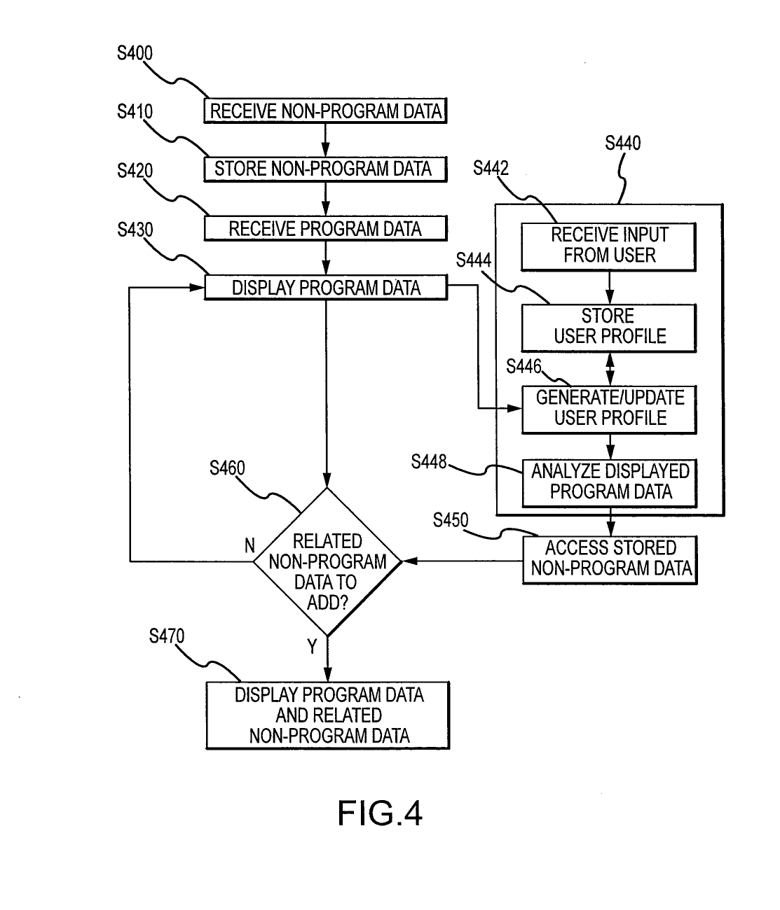

Another exemplary process of displaying non-program data is illustrated by the flowchart shown in FIG. 4. The flowchart of FIG. 4 differs from the flowchart of FIG. 2 only with respect to step S240 of FIG. 2. Thus, steps S400, S410, S420, S430, S450, S460 and S470 in FIG. 4 may be described as above with respect to corresponding steps S200, S210, S220, S230, S250, S260 and S270 in FIG. 2. However, in step S440, the analysis may be expanded to include a user profile feature, as described above with respect to corresponding steps S340, S342, S344, S346 and S348 in FIG. 3. Thus, no further discussion of FIG. 4 is necessary.

An exemplary system 100 for displaying non-program data is illustrated by the block diagram shown in FIG. 5. The block diagram is a simplified representation of a system, omitting details that are not necessary for understanding and implementation based on systems already known in the art.

The system 100 may comprise a client device 110, a program data source 120, a non-program data source 130 and a storage device 140. The program data source 120 may be any known or hereafter developed device or system that is capable of transmitting or otherwise providing program data from a central source to a plurality of client devices. Examples of known systems include cable and satellite broadcasting systems. Similarly, the non-program data source 130 may be any known or hereafter developed device or system that is capable of transmitting or otherwise providing program data. In particular, it should be understood that the non-program data source 130 may be included in the program data source 120. For example, a content provider may supply both program data and non-program data as is known in the art. Alternatively or additionally, the non-program data source 130 may be separate from the program data source 120 as illustrated, such as a local content provider. The storage device 140 may be any known or hereafter developed device or system that is capable of storing the non-program data from the non-program data source 130. Although shown separately, it should be understood that the storage device 140 may be part of the non-program data source 130 itself.

The client device 110 may be any known or hereafter developed device or system that is capable of receiving, processing and displaying program data and non-program data. Although no known systems may currently have the particular functionalities or capabilities for implementing all aspects contemplated in this disclosure, only slight modifications in hardware and/or software may be necessary in some cases to implement various features. Thus, only general components are described herein.

As illustrated in FIG. 5, the client device 110 may include a receiver 112, a display 114 and a processor 116. Each of these components may be separate devices or integrated as a single device. As should be understood, these components provide the functionality of receiving, processing and displaying program data and non-program data for the client device 110. As such, any suitable device(s), either known or hereafter developed, may be used.

The exemplary system 100 may be used to implement any of the processes described above with respect to FIGS. 1-4, each component carrying out corresponding steps of the processes as necessary. It should be understood that the interconnections or links between components may be implemented in any suitable manner, including wired, wireless, data bus, and the like. Further, the particular configuration illustrated only exemplary and is intended for understanding rather than to be limiting.

It should also be understood that a user input device or interface and possibly another storage device may be included to carry out the processes illustrated in FIGS. 3 and 4 that include the user profile feature. Such additional components may be part of the client device, for example, or a separate system that is accessible at least by the processor of the client device to allow the analysis to be based on the user profile as well.

Another exemplary system 200 for displaying non-program data is illustrated by the block diagram shown in FIG. 6. The block diagram of FIG. 6 differs from the block diagram of FIG. 5 only with respect to the location of the storage device. Thus, elements 210, 212, 214, 216, 220 and 230 in FIG. 6 may be described as above with respect to corresponding elements 110, 112, 114, 116, 120 and 130 in FIG. 5. However, a storage device 218, which may generally functionally correspond to the storage device 140 in FIG. 5, may be included as part of the client device 210. As such the storage device 218 may store only data for the specific client device.

The characteristics of the various embodiments shown may be combined with one another. For example, it is possible to envisage providing both display of non-program data during breaks in the program data and simultaneously with the program data.

Although various details of the present invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present

1. A process of processing, displaying and/or presenting non-program data, comprising:
receiving and at least one of processing, displaying and presenting program data at a client device;
analyzing the program data processed, displayed or presented at the client device; and
at least one of processing, displaying and presenting non-program data at the client device based on the analysis of the processed, displayed or presented program data. wherein processing, displaying or presenting the non-program data comprises displaying a user selectable link to data related to the processed, displayed or presented program data.

2. The process of claim 1, wherein the client device includes a storage device, the process further comprising storing the non-program data in the storage device for at least one of processing, displaying and presenting based on the analysis.

3. The process of claim 1, wherein analyzing the processed, displayed or presented program data comprises analyzing content of the processed, displayed or presented program data.

4. The process of claim 3, wherein analyzing the content of the processed, displayed or presented program data comprises identifying at least one of a sound, a word, an image and an event in the processed, displayed or presented program data.

5. The process of claim 1, wherein analyzing the processed, displayed or presented program data comprises analyzing metadata of the processed, displayed or presented program data.

6. The process of claim 1, wherein processing, displaying or presenting the non-program data comprises displaying advertising related to the processed, displayed or presented program data.

7. (canceled)

8. The process of claim 1, wherein processing, displaying or presenting the non-program data comprises inserting the non-program data into a signal carrying the program data.

9. The process of claim 8, wherein inserting the non-program data into the signal comprises overwriting preexisting non-program data in the signal.

10. The process of claim 1, wherein processing, displaying or presenting the non-program data comprises adding the non-program data to the program data and simultaneously displaying the non-program data and a portion of the program data.

11. The process of claim 1, further comprising generating a user profile based at least in part on the processed, displayed or presented program data, wherein analyzing the processed, displayed or presented program data includes analyzing the user profile.

12. The process of claim 11, wherein generating the user profile is based on at least one user preference.

13. The process of claim 1, wherein analyzing the processed, displayed or presented program data comprises a heuristic analysis.

14. A system for processing, displaying and/or presenting non-program data, comprising:
a receiver configured to receive a signal including program data; and
a processor configured to analyze program data received by the receiver and to cause the non-program data to be at least one of processed, displayed and presented based on the analysis of the processed, displayed or presented program data, wherein the non-program data comprises a user selectable link to data.

15. The system of claim 14, further comprising a display configured to display program data received by the receiver;
wherein the processor is configured to cause the display to display non-program data based on the analysis of the processed, displayed or presented program data.

16. The system of claim 14, further comprising a storage device configured to store non-program data, wherein the processor is configured to access the non-program data stored by the storage device and to provide selected non-program data based on the analysis of the processed, displayed or presented program data.

17. The system of claim 16, wherein the storage device comprises a client device.

18. The system of claim 14, wherein the processor is configured to analyze content of the processed, displayed or presented program data.

19. The system of claim 18, wherein the processor is configured to identify at least one of a sound, a word, an image and an event in the processed, displayed or presented program data.

20. The system of claim 14, wherein the non-program data comprises advertising.

21. (canceled)

22. The system of claim 14, further comprising a user profile, wherein the processor is configured to analyze the user profile and the processed, displayed or presented program data.

23. The system of claim 14, wherein the processor is configured to perform a heuristic analysis of the processed, displayed or presented program data.

24. A computer-readable storage medium including instructions for:
receiving and at least one of processing, displaying and presenting program data at a client device;
analyzing the program data processed, displayed or presented at the client device; and
at least one of processing, displaying and presenting non-program data at the client device based on the analysis of the processed, displayed or presented program data. wherein processing, displaying or presenting the non-program data comprises displaying a user selectable link to data related to the processed, displayed or presented program data.

25. The computer-readable storage medium of claim 24, wherein processing, displaying or presenting the non-program data comprises inserting the non-program data into a signal carrying the program data.

26. The computer-readable storage medium of claim 24, wherein processing, displaying or presenting the non-program data comprises adding the non-program data to the program data and simultaneously displaying the non-program data and a portion of the program data.
